(19) United States
(12) Patent Application Publication
(10) Pub. No.: US 2007/0203716 A1
(43) Pub. Date: Aug. 30, 2007

(54) METHOD, SYSTEM, AND COMPUTER PROGRAM PRODUCT FOR IMPLEMENTING PART PERFORMANCE MANAGEMENT SERVICES

(75) Inventors: Michael W. Bolch, Raleigh, NC (US); Michael A. Boraas, Eligin, MN (US); Biao Cai, Carmel, NY (US); Ghassan Chidiac, Poughkeepsie, NY (US); Andrew J. Dubois JR., Howey-In-The-Hills, FL (US); Donald C. Gorman, Poughkeepsie, NY (US); Eric T. Lambert, Wappingers Falls, NY (US); John S. Maresca, Hopewell Junction, NY (US); Kenneth A. Scea, Poughkeepsie, NY (US); Joseph H. Torella, Lagrangeville, NY (US); Matthew H. Zemke, Rochester, MN (US); Paul A. Zulpa, Woodbury, CT (US)

Correspondence Address: CANTOR COLBURN LLP - IBM FISHKILL, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/307,821

(22) Filed: Feb. 24, 2006

(51) Int. Cl. G06Q 10/00; G06Q 30/00

(52) U.S. Cl. 705/1

(57) ABSTRACT

A method, system, and computer program product for implementing part performance management services is provided. The method includes gathering service data for products. The serviced components of the products are identified in the service data by replacement component part numbers. The method also includes mapping the service data to manufacturing data for products of manufacture by matching at least one data element common to both of the service data and the manufacturing data. The components of the products of manufacture are identified in the manufacturing data by production part numbers. The method further includes identifying which of the products of manufacture have been serviced based upon results of the mapping.

### BACKGROUND OF THE INVENTION

The present invention relates generally to data processing and, in particular, to a method, system, and computer program product for implementing part performance management services.

Manufacturing enterprises typically employ manufacturing execution system (MES) software, manufacturing control system (MCS) software, etc., for carrying out various production activities. In addition, databases of product and component information are maintained, which store, for example, build plans, bills of materials, manufacturing records, and vendor or supplier information for components built and provided by vendors of the manufacturing enterprise. The component data is typically stored and retrieved using a part identification scheme that identifies each particular component manipulated in the manufacturing process. For example, components may be identified in a manufacturing data warehouse by a production part number. The production part number specifies a unique identifier for each part that goes into a product and may also specify a particular supplier of the part.

Once the finished items are shipped out of the manufacturing facility, the manufacturing enterprise is afforded little, if any, performance information regarding these items (e.g., documented product defects, component failures, and related issues). This is, in part, due to the varying nature of product servicing employed by service entities in the field which are tasked with maintaining the operational efficiency of the products on the customer side. When a product is serviced and a component therein is diagnosed as “failed”, for example, the field service entity is concerned with replacing the failed component with either an identical component or an equivalent thereof (also referred to as a field replacement unit (FRU)). The FRU may be an equivalent part that is manufactured by a different supplier than that of the originally installed component. Oftentimes, an identical component is not available or on hand, so the field service entity replaces the failed component with an available FRU. When a service or repair record for the servicing activity is generated, the replacement component is identified in the record by a corresponding FRU identifier. Multiple parts produced by multiple suppliers each have a unique identifier. For the equivalent parts, the FRU specified in a service record identifies one of potentially many different part numbers. Accordingly, even if the manufacturing entity is supplied with a copy of the service or repair record, it may not be able to reconcile the particular service issues noted therein with its existing manufacturing data, and consequently, would be unable to identify performance issues for its manufactured products.

What is needed, therefore, is a way to correlate service data for products of manufacture with corresponding manufacturing data for the products in order to evaluate the performance of the products and/or its individual components.

### SUMMARY OF THE INVENTION

The foregoing discussed drawbacks and deficiencies of the prior art are overcome or alleviated by a method, system, and storage medium for implementing part performance management services. The method includes gathering service data for products. The serviced components of the products are identified in the service data by replacement component part numbers. The method also includes mapping the service data to manufacturing data for products of manufacture by matching at least one data element common to both of the service data and the manufacturing data. The components of the products of manufacture are identified in the manufacturing data by production part numbers. The method further includes identifying which of the products of manufacture have been serviced based upon results of the mapping.

The system for implementing part performance management services includes a host system and an application executing on the host system. The application performs a method. The method includes gathering service data for products. The serviced components of the products are identified in the service data by replacement component part numbers. The method also includes mapping the service data to manufacturing data for products of manufacture by matching at least one data element common to both of the service data and the manufacturing data. The components of the products of manufacture are identified in the manufacturing data by production part numbers. The method further includes identifying which of the products of manufacture have been serviced based upon results of the mapping.

A computer program product for implementing part performance management services includes instructions for executing a method. The method includes gathering service data for products. The serviced components of the products are identified in the service data by replacement component part numbers. The method also includes mapping the service data to manufacturing data for products of manufacture by matching at least one data element common to both of the service data and the manufacturing data. The components of the products of manufacture are identified in the manufacturing data by production part numbers. The method further includes identifying which of the products of manufacture have been serviced based upon results of the mapping.

### BRIEF DESCRIPTION OF THE DRAWINGS

Referring to the exemplary drawings wherein like elements are numbered alike in the several FIGURES:

FIG. 1 is a block diagram of a system upon which the part performance management services may be implemented in exemplary embodiments;

FIG. 2 is a flow diagram describing a process for implementing the part performance management services in exemplary embodiments;

FIG. 3 is a user interface screen for monitoring the performance of a selected part in exemplary embodiments;

FIG. 4 is a user interface screen for performing trend analysis of a problematic part in exemplary embodiments;

FIG. 5 is a user interface screen for performing trend analysis of a problematic part by supplier in exemplary embodiments;

FIGS. 6A-6B are user interface screens for performing a supplier-level analysis in exemplary embodiments; and

FIGS. 7A-7B are user interface screens depicting sample time-to-fail performance data in exemplary embodiments.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### DETAILED DESCRIPTION OF THE INVENTION

Disclosed herein is a method, system, and storage medium for implementing part performance management services. The part performance management services enable a manufacturing enterprise to correlate service data for products of manufacture with corresponding manufacturing data for the products in order to evaluate the performance of the products and/or its individual components.

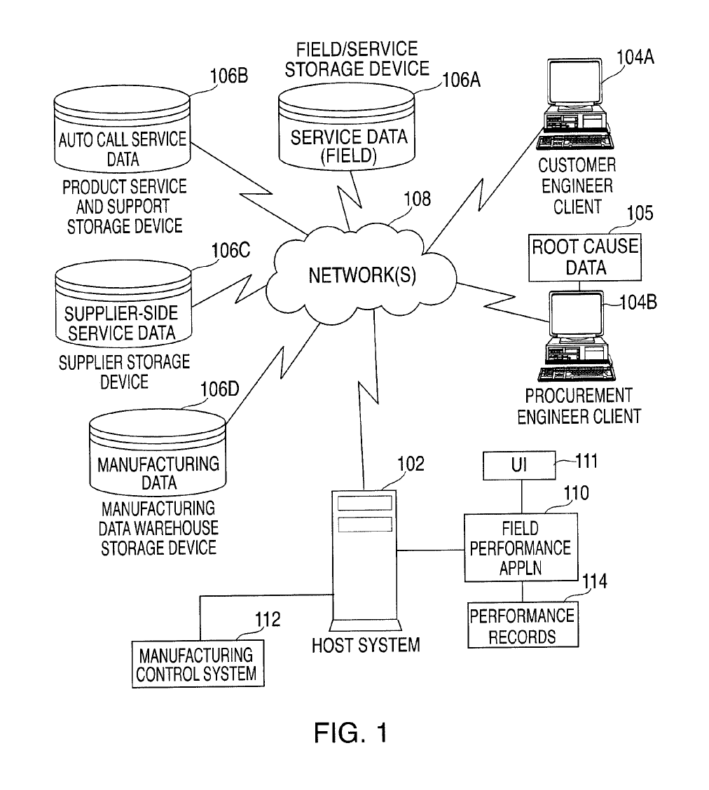

Turning now to FIG. 1, a block diagram of a system upon which the part performance management services may be implemented in accordance with exemplary embodiments will now be described. The system of FIG. 1 includes a host system 102 in communication with client systems 104A-104B and storage devices 106A-106D over a network 108. Host system 102 may be implemented by a manufacturing entity that builds products for end users such as commercial, military, and organizational establishments, as well as personal consumers. The manufacturing entity may be an original equipment manufacturer (OEM). The part performance management services may be adapted for implementation across a wide variety of enterprise applications. For example, in the computer manufacturing industry, high end products such as mainframes and network servers may be subject to service and maintenance activities that involve, e.g., routine on-site maintenance checks performed at the purchasing entity's location by a service department of the manufacturing enterprise or representatives authorized by the manufacturing enterprise; an automated call center that is electronically contacted via a signal generated by a faulty component and transmitted over a network; maintenance or repair actions performed by a supplier of components of the serviced product, etc.

By contrast, low end products, such as personal computers and laptops may be subject to different modes of service and maintenance that involve, e.g., physical transport of the products to an authorized service center of the manufacturing entity. These varying types of maintenance and service activities yield service information that may comprise a variety of different formats. For example, a service center that deals with low end products may generate a service record, a warranty claim record, a Help Desk record, etc., that documents the nature of issue and repair action taken. These records may be stored in various formats and at various locations. Servicing performed on high end products may yield repair action records, automated call center records, and field repair records, each of which may comprise various formats. The part performance management services are adaptable in order to manipulate and utilize service data produced in response to any of these activities, or a combination thereof.

Host system 102 may be implemented using one or more servers or suitable high-speed processors operating in response to a computer program stored in a storage medium accessible by the server or servers. The host system 102 may operate as a network server (e.g., a web server) to communicate with network entities such as client systems 104A-104B and storage devices 106A-106D. The host system 102 may handle sending and receiving information to and from network entities, e.g., user systems 104A-104B, storage devices 106A-106D, and may perform associated tasks.

Host system 102 may also operate as an application server. In accordance with exemplary embodiments, the host system 102 executes one or more computer programs to perform part performance management services. These one or more computer programs are referred to collectively herein as a field performance application 110. In addition, the host system 102 may further implement a material control system (MCS) application 112, as well as other suitable applications typically employed by a manufacturing enterprise. Manufacturing control system application 112 identifies the parts that go into the manufacture of products by, e.g., production part numbers assigned to these parts. The host system 102 processes manufacturing data (e.g., build plans, Bills of Material, etc.) via the field performance application 110, manufacturing control system application 112, and other suitable applications.

As previously described, it is understood that separate servers may be utilized to implement the network server functions and the application server functions of host system 102. Alternatively, the network server and the application server may be implemented by a single server executing computer programs to perform the requisite functions described with respect to host system 102.

The field performance application 110 may include a user interface (UI) 111 for enabling individuals of the manufacturing entity to perform part performance management activities, as described further herein. Performance records 114 are generated by the field performance application 110 and may be stored locally on host system 102 or at a remote location, as desired. Performance records 114 store results of part performance searches and analyses as described further herein.

Host system 102 is in communication with storage devices 106A-106D, which may be implemented using a variety of devices for storing electronic information. It is understood that one or more of the storage devices 106A-106D may be implemented using memory contained in the host system 102, or may be separate physical devices. The storage devices 106A-106D are logically addressable as consolidated data sources across a distributed environment that includes network 108. Information stored in the storage devices 106A-106D may be retrieved and manipulated via the host system 102. In an exemplary embodiment, the host system 102 operates as a database server and coordinates access to application data including data stored on storage devices 106A-106D.

Storage devices 106A-106D include a field/service storage device 106A, a product service and support storage device 106B, a supplier storage device 106C, and a manufacturing data warehouse storage device 106D. Storage device 106A refers to a storage facility that houses, e.g., service and/or warranty records for products serviced by one or more product servicing entities that provide repair and maintenance services for low end products (e.g., PCs, laptops, etc.). A service record is created that documents the nature of the repair and may include information such as machine serial number, machine type, FRU identifier, FRU family, fall out date (i.e., failure date or service issue date), cost of repair or servicing, customer name and address, service entity name and address, etc. Alternatively, a warranty claim record may be generated if the product serviced is under warranty. These records may be acquired by a customer engineer via customer engineer client system 104A and stored in storage device 106A. While only one field/service storage device 106A is shown in FIG. 1, it will be understood that multiple field/service storage devices 106A may be implemented in order to realize the advantages of the invention. The service record data is manipulated by the field performance application 110 as described further herein.

Product service and support storage device 106B refers to a storage facility that houses service data relating to high end products (e.g., mainframes, network servers, etc.) received as a result of automated call center transactions. Product service and support storage device 106B may be implemented and directly accessed by the host system 102, whereby products installed at a purchasing entity's location communicate with the host system 102 when an issue with a product or component is detected. Call center records may be generated as a result of this detection and stored in storage device 106B where they are manipulated by the field performance application 110. Examples of the types of information stored in the call center records of storage device 106B include production part numbers, product serial numbers, machine type, machine serial number, etc.

Supplier storage device 106C refers to a storage facility that houses return part information received from a supplier for parts that have been returned to the supplier for replacement and/or repair. The return part information may be implemented for low-to-mid range products. The information provided in supplier storage device 106C may be acquired, e.g., by scanning the returned part in order to determine the supplier of the part. The field replacement unit information associated with the returned part may be acquired from a service record as described above with respect to field/service storage device 106A.

The service information stored in storage devices 106A-106C are manipulated by the field performance application 110 in order to determine the occurrences of field pulls associated with serviced products. A field pull refers to an instance of component failure that occurs after a product has been shipped to a customer or end user.

Manufacturing data warehouse storage device 106D refers to a storage facility that houses floor control system data for all products manufactured by the manufacturing entity (e.g., low-to-high end products). Low end product data may be stored in the form of shipping records and data result from scanning devices (e.g., bar code scanning). Mid-to-high end product data may be stored in the form of system inventory tables. Examples of the types of information that may be stored in manufacturing data warehouse storage device 106D include build records, ship records, scan records, etc. Build records provide product and component information such as production part numbers, manufacturing product serial numbers, part quantities, manufacturing site, machine type, machine serial number, and commodity. Ship records may provide information such as shipping dates and installation dates. Scan records may be generated in response to scanning components, which then provide vendor codes, supplier names, date codes, to name a few. A date code refers to the vintage of a component and may be used in determining how long a part survives before it fails.

The storage devices 106A-106D may be implemented using one or more servers operating in response to a computer program stored therein or in a storage medium accessible by the server or servers (e.g., in a manner similar to that described above with respect to host system 102).

Network 108 may be any type of known network including, but not limited to, a local area network (LAN), a wide area network (WAN), a global network (e.g. the Internet), a private network (e.g. an Intranet), and a virtual private network (VPN). The network 108 may be implemented using a wireless network or any kind of physical network implementation known in the art. Network entities (e.g., client systems 104A-104B and one or more of storage devices 106A-106D), may be coupled to the host system 102 through multiple networks (e.g., intranet and Internet) so that not all network entities are coupled to the host system 102 through the same network. One or more of the network entities and the host system 102 may be connected to the network 108 in a wireless fashion.

Client systems 104A-104B refer to communication devices through which users at one or more geographic locations may contact the host system 102. Client system 104A is operated by a customer engineer of the manufacturing entity of host system 102. The customer engineer acquires service information (e.g., service records, repair action records, warranty claim records) from various sources (e.g., authorized service centers, suppliers, etc.) and stores the information in corresponding storage devices 106A-106C where they are manipulated by the field performance application 110 as described herein. It will be understood that multiple customer engineer client systems 104A may be implemented by the part performance management services.

Client system 104B is operated by a procurement engineer of the manufacturing entity of host system 102. The procurement engineer is tasked with monitoring, interpreting, and resolving part issues via the field performance application 110 and user interface 111. Recurring or persistent issues can be tracked by storing the issues on client system 104B (e.g., as root cause data 105), or in a remote location accessible to client system 104B, whereby additional monitoring and analysis can be performed using the search facilities provided by the field performance application 110.

Each client system 104A-104B may be implemented using a general-purpose computer executing a computer program for carrying out the processes described herein. The client systems 104A-104B may be personal computers (e.g., a lap top, a personal digital assistant) or host attached terminals. If the client systems 104A-104B are personal computers, the processing described herein may be shared by a client system and the host system 102 (e.g., by providing an applet to the client system).

As indicated above, service data relating to product issues and repairs may come in many different forms and from a variety of different sources. Also, with respect to components at issue, the service records generated provide identifying information at a FRU level which is not compatible with the component data known to the manufacturer of the products subject to the component issues. The field performance application 110 provides a bridge for integrating field replacement unit (FRU)-level data with manufacturing data.

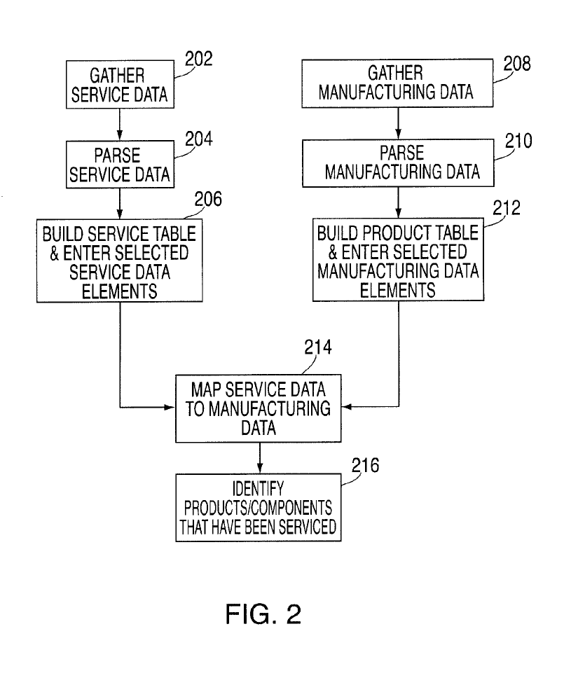

Turning now to FIG. 2, a flow diagram describing a process for implementing the part performance management services in accordance with exemplary embodiments will now be described. At step 202, service data for products produced by the manufacturing entity of host system 102 is gathered from one or more of storage devices 106A-106C via the field performance application 110. As indicated above, the information may be initially acquired by a customer engineer and stored in these devices 106A-106C. In alternative exemplary embodiments, the information may be electronically transferred or copied to one or more of storage devices 106A-106C. The field performance application 110 parses the service data into constituent service data elements at step 204. Examples of service data elements include machine serial number, machine type, FRU, FRU family, FRU fall out date, etc. These service data elements may be filtered by the field performance application 110. For example, there may be service records stored in storage device 106B that document non-reportable field instances. Non-reportable field instances refer to, e.g., actions reported such as a service call that is determined to be a false alarm, or other action that does not rise to the level of requiring component service activities. Thus, a call center record may be generated and stored in storage device 106B, which includes non-reportable field instances. These non-reportable field instances may be filtered and the remaining reportable field instances used in building a service table. At step 206, a service table is built and selected service data elements are entered into therein. A sample service table data structure is shown below:

| | | | | |
|---|---|---|---|---|
| MACHINE | MACHINE | FRU | FRU FAMILY | FALL OUT |
| SERIAL | TYPE | | | DATE |
| NUMBER | | | | |

At step 208, manufacturing data for products of manufacture is gathered from manufacturing data warehouse storage device 106D. The manufacturing data is parsed into constituent product data elements at step 210. Examples of manufacturing data elements include machine serial number, machine type, production part number product serial number, part quantity, commodity, vendor code, and installation date. The manufacturing data may be filtered in order to remove instances of products/components that have not been shipped to customers (i.e., the field performance application 110 is concerned with only those products that have left the manufacturing site). At step 212, a product table is built and selected product data elements are entered into the table. A sample product table data structure is shown below:

| | | | | | | | |
|---|---|---|---|---|---|---|---|
| MACHINE | MACHINE | PRODUCTION | PRODUCT | PART | CMDTY | VC | INSTALL |
| SERIAL | TYPE | PART | SERIAL | QTY | | | DATE |
| NUMBER | | NUMBER | NUMBER | | | | |

At step 214, the service data in the service table is mapped to corresponding manufacturing data in the product table. This may be accomplished by identifying one or more common data elements between the tables (e.g., machine serial number, machine type). The field performance application 110 includes logic for enabling the tables to be searchable by one or more of these data elements in the tables.

At step 216, products and/or product components that have been serviced are identified (i.e., field pull instances). This may be accomplished by searching techniques provided by the user interface 111 of the field performance application 110. The results of the searching may be analyzed to determine field pull rates by, e.g., part number, supplier, or other data element desired. A confidence level may be assigned to these field pull rates and the data resulting from the searching may be normalized by the field performance application 110 in order to remove any wayward data.

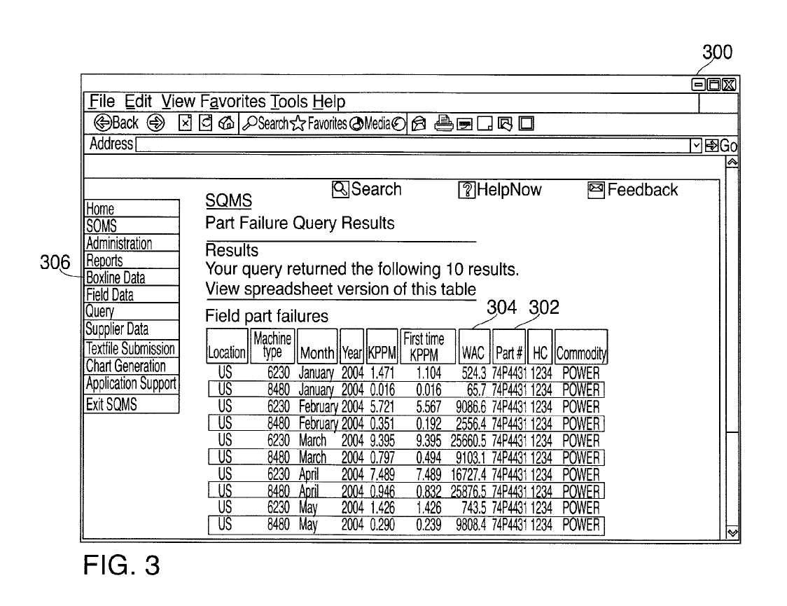

As indicated above, the field performance application 110 enables a user to perform searches and analyses of product component data. The user interface screens of FIGS. 3-7 illustrate some of the features of the field performance application 110, as will now be described.

The user interface screen 300 of FIG. 3 enables a user to monitor the performance of a selected part. A user selects option 306 in order to perform a field data query. The results of a part number search for part number “74P4431” (column 302) are shown FIG. 3. Column 304 indicates a weighted average cost (WAC) for the part, which reflects the cost to support a particular machine type associated with the part. The cost is weighted because oftentimes there are both part costs and related service costs involved with the servicing of the part. The HC column indicates the supplier identified with the part. Accordingly, the user can view problems identified for a particular part number and its corresponding costs.

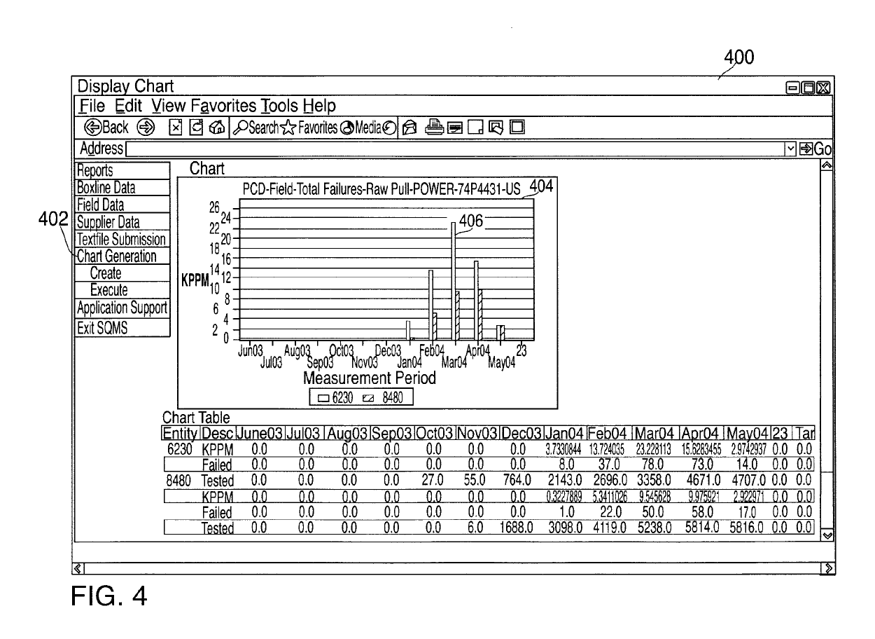

FIG. 4 is a user interface screen 400 for performing trend analysis of a problematic part in exemplary embodiments. As shown in user interface screen 400, the user generates a chart via option 402 and views the resulting chart 404. Chart 404 enables the user to perform a comparison, or trend analysis, for the part in order to assess its performance over time. Assuming that the accumulated data is incomplete for the months of April and May 2004, the chart 404 confirms problem trend occurring with respect to the part “74P4431”, as reflected in the increased dimensions of bars for January 2004 through March 2004 (bar 406).

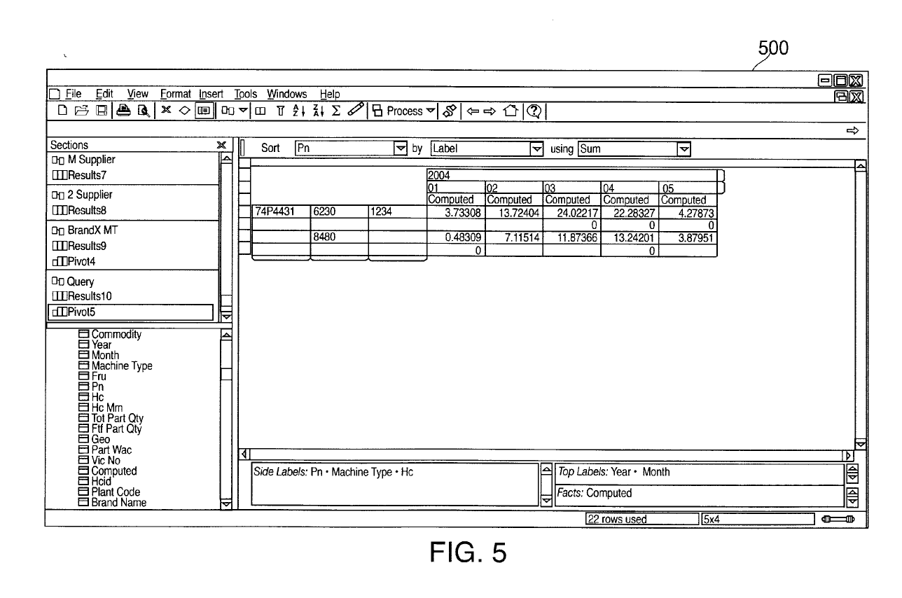

FIG. 5 is a user interface screen for performing trend analysis of a problematic part by supplier in exemplary embodiments. As shown in the user screen 500 of FIG. 5, the data provided for the months of January 2004 through May 2004 reflect a correlation between supplier 1234 and the part documented in FIG. 3 as being a problematic part subject to the trend analysis.

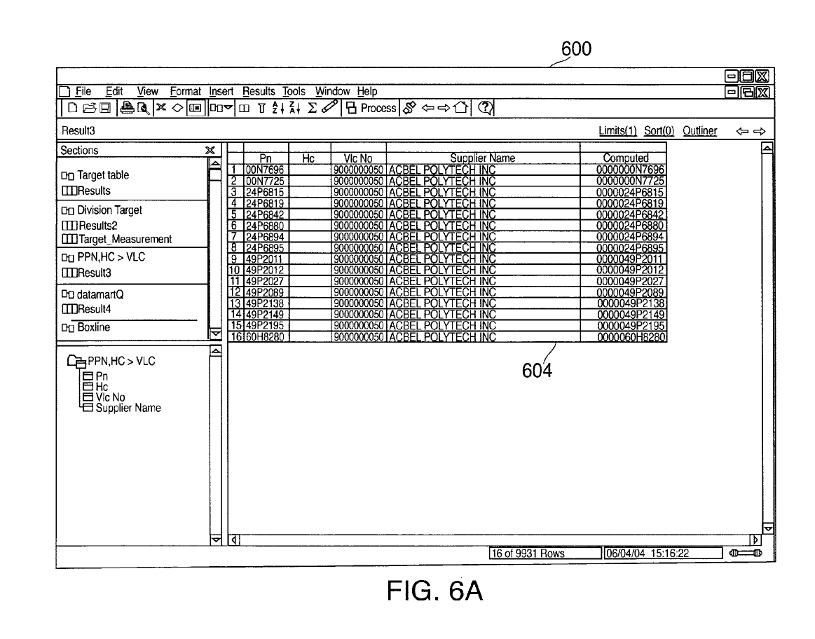

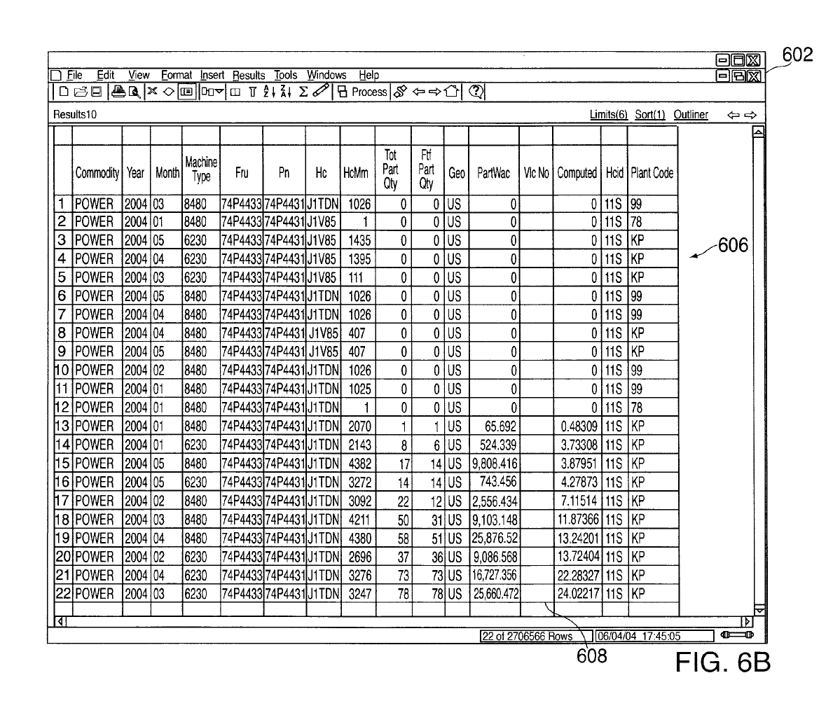

FIGS. 6A-6B are a supplier name reference table 600 and user interface screen 602 for performing a supplier-level analysis in exemplary embodiments. The supplier name reference table 600 includes fields 604 that identify each of the suppliers of the manufacturing entity by vendor code (VLC) and by supplier name. The supplier name reference table 600 is loaded into the field performance application 110, which in turn populates the supplier level analysis table 606 with the particular vendor information (in column 608) for the vendor subject to analysis.

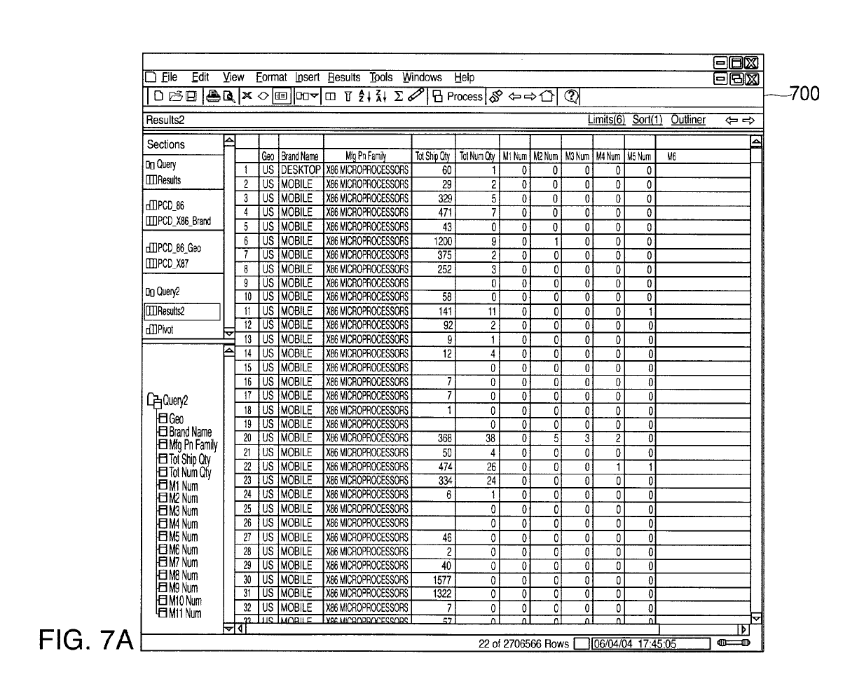

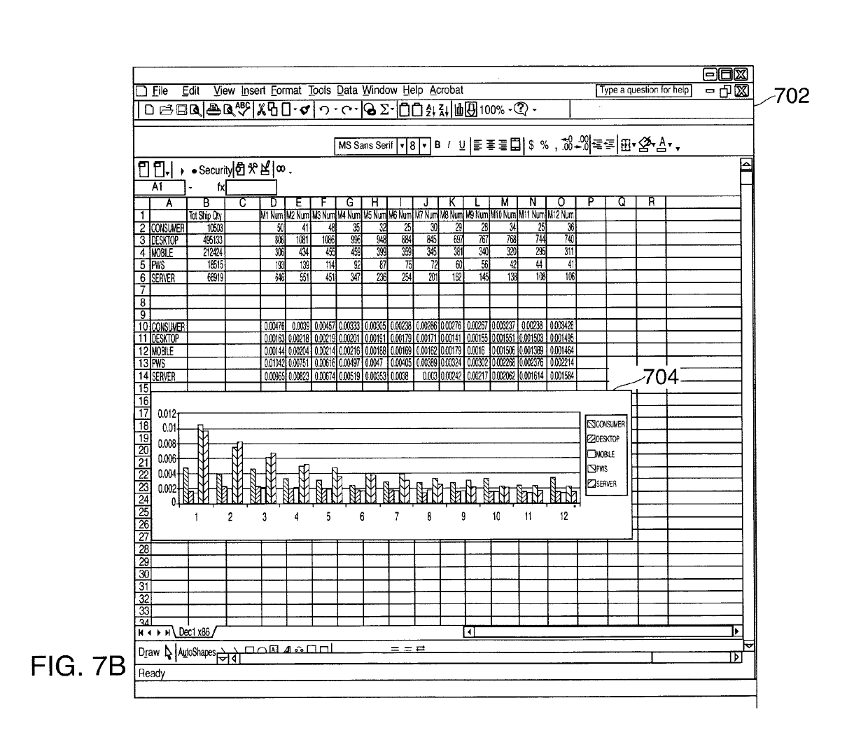

FIGS. 7A-7B are a brand name reference table 700 and user interface screen 702 depicting sample time-to-fail performance data in exemplary embodiments. Brand reference table 700 is loaded into the field performance application 110, which in turn populates fields provided in user interface screen 702 with brand data. The user interface screen 702 enables a user to view field time to fail data by brand via, e.g., a chart 704 shown in user interface screen 702.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method for implementing part performance management services, comprising:
gathering service data for products, wherein serviced components of the products are identified in the service data by replacement component part numbers;
mapping the service data to manufacturing data for products of manufacture by matching at least one data element common to both of the service data and the manufacturing data, wherein components of the products of manufacture are identified in the manufacturing data by production part numbers; and
identifying which of the products of manufacture have been serviced based upon results of the mapping.

2. The method of claim 1, wherein the gathering service data for products includes:
parsing at least one of service records, repair records, and service and support records into data elements;
building a service table for each of the products serviced; and
entering selected data elements into corresponding fields in the service table.

3. The method of claim 2, further comprising:
performing at least one of:
scanning the products of manufacture and parsing results of the scanning into data elements; and
parsing at least one of build records, shipping records, and scan records into data elements;
building a product table for each of the products of manufacture; and
entering selected data elements resulting from the performing at least one of scanning and parsing into corresponding fields in the product table;
wherein the mapping includes matching service tables to corresponding product tables via the at least one data element.

4. The method of claim 1, wherein the service data includes the replacement component part numbers and at least one of:
service issues identified for the products;
dates of service issues identified for the products;
machine types of the products; and
machine serial numbers of the products.

5. The method of claim 1, wherein the manufacturing data includes the product part numbers and at least one of:
machine serial numbers machine types;
product serial numbers;
part quantities;
manufacturing sites;
commodities;
product shipping dates;
product installation dates;
date codes identifying vintage of components; and
vendor codes identifying vendors of the components of the products of manufacture.

6. The method of claim 1, wherein the identifying which of the products of manufacture have been serviced includes identifying the production part numbers corresponding to the serviced components.

7. The method of claim 1, wherein the identifying which of the products of manufacture have been serviced includes identifying vendors of the production part numbers corresponding to the serviced components.

8. A system for implementing part performance management services, comprising:
a host system;
an application executing on the host system, performing:
gathering service data for products, wherein serviced components of the products are identified in the service data by replacement component part numbers;
mapping the service data to manufacturing data for products of manufacture by matching at least one data element common to both of the service data and the manufacturing data, wherein components of the products of manufacture are identified in the manufacturing data by production part numbers; and
identifying which of the products of manufacture have been serviced based upon results of the mapping.

9. The system of claim 8, wherein the gathering service data for products includes:
parsing at least one of service records, repair records, and service and support records into data elements;
building a service table for each of the products serviced; and
entering selected data elements into corresponding fields in the service table.

10. The system of claim 8, wherein the service data includes the replacement component part numbers and at least one of:
service issues identified for the products;
dates of service issues identified for the products;
machine types of the products; and
machine serial numbers of the products.

11. The system of claim 8, wherein the manufacturing data includes the product part numbers and at least one of:
machine serial numbers
machine types;
product serial numbers;
part quantities;
manufacturing sites;
commodities;
product shipping dates;
product installation dates;
date codes identifying vintage of components; and
vendor codes identifying vendors of the components of the products of manufacture.

12. The system of claim 8, wherein the identifying which of the products of manufacture have been serviced includes identifying the production part numbers corresponding to the serviced components.

13. The system of claim 8, wherein the identifying which of the products of manufacture have been serviced includes identifying vendors of the production part numbers corresponding to the serviced components.

14. A computer program product for implementing part performance management services, the computer program product including instructions for executing a method, the method comprising:
gathering service data for products, wherein serviced components of the products are identified in the service data by replacement component part numbers;
mapping the service data to manufacturing data for products of manufacture by matching at least one data element common to both of the service data and the manufacturing data, wherein components of the products of manufacture are identified in the manufacturing data by production part numbers; and
identifying which of the products of manufacture have been serviced based upon results of the mapping.

15. The computer program product of claim 14, wherein the gathering service data for products includes:
parsing at least one of service records, repair records, and service and support records into data elements;
building a service table for each of the products serviced; and
entering selected data elements into corresponding fields in the service table.

16. The computer program product of claim 15, further comprising instructions for:
performing at least one of:
scanning the products of manufacture and parsing results of the scanning into data elements; and
parsing at least one of build records, shipping records, and scan records into data elements;
building a product table for each of the products of manufacture; and
entering selected data elements resulting from the performing at least one of scanning and parsing into corresponding fields in the product table;
wherein the mapping includes matching service tables to corresponding product tables via the at least one data element.

17. The computer program product of claim 14, wherein the service data includes the replacement component part numbers and at least one of:
service issues identified for the products;
dates of service issues identified for the products;
machine types of the products; and
machine serial numbers of the products.

18. The computer program product of claim 14, wherein the manufacturing data includes the product part numbers and at least one of:
machine serial numbers
machine types;
product serial numbers;
part quantities;
manufacturing sites;
commodities;
product shipping dates;
product installation dates;
date codes identifying vintage of components; and
vendor codes identifying vendors of the components of the products of manufacture.

19. The computer program product of claim 14, wherein the identifying which of the products of manufacture have been serviced includes identifying the production part numbers corresponding to the serviced components.

20. The computer program product of claim 14, wherein the identifying which of the products of manufacture have been serviced includes identifying vendors of the production part numbers corresponding to the serviced components.
